(19) United States
(12) Patent Application Publication
(10) Pub. No.: US 2017/0061018 A1
(43) Pub. Date: Mar. 2, 2017

(54) MetaSpace: augmented data propagation through speech communication

(71) Applicant: Timothy Reynard Isaac, Brea, CA (US)

(72) Inventor: Timothy Reynard Isaac, Brea, CA (US)

(21) Appl. No.: 14/998,441

(22) Filed: Jan. 4, 2016

Related U.S. Application Data
(60) Provisional application No. 62/124,782, filed on Jan. 2, 2015.

(51) Int. Cl. G06F 17/30

(52) U.S. Cl. CPC G06F 17/30867; G06F 17/30899

(57) ABSTRACT

Data and/or information propagation via speech communication of a word or phrase-like code; a user interaction associated with a word or phrase-like code; the code encapsulates data elements; the encapsulated data elements being expanded due to code activation through manual input into an interface or triggered by acquisition of a signal or signals; allowing selection of expanded data elements; allowing storage of selected data elements within a user identified data repository as a marker or index; allowing selected data elements to be available for retrieval upon user request and presented via a marker collection interface; and enabled with channels for communication among user-identified marker collection interfaces and other network environments.

### CROSS-REFERENCE TO RELATED APPLICATIONS

This application relates to and claims the benefit of U.S. Provisional Application No. 6/124,782 filed Jan. 2, 2015, the contents of which is expressly incorporated by reference herein.

### STATEMENT RE: FEDERALLY SPONSORED RESEARCH/DEVELOPMENT

Not Applicable

### BACKGROUND

A typical internet search engine, to use medical terminology, may be thought of as a general practitioner. It looks at the Internet in general, and tries to return search results for all data stored across the entire World Wide Web that seems to match the user's requested search criteria. This is a monumental task. Currently, Google uses approximately 920,000 servers to index the information from 30 trillion web pages which equals an index size of about 100,000,000 GB (100 million gigabytes) of disk space; according to the Statistic Brain Research Center (statisticbrain.com). Interestingly, Bing and Yahoo both have adopted the general practitioner mindset as each indexes about half the number of the web pages as Google does. So here you have the 3 top Internet search engines that are all essentially the general practitioners of search, so to speak. The method of this present disclosure is a type of search engine specialization. The specialized search method is not as concerned with web pages themselves per se, but rather the search criteria and search results in particular. The method is somewhat of an inversion of search wherein the search criteria is defined first and then used to encapsulate pre-filtered and pre-assembled data elements and/or information, including metadata, which the data supplier/administrator wants a user to find. The user is then somehow made aware of the search criterion by the data supplier and when a user activates the pre-defined search word or phrase; only the particular pre-filtered, pre-assembled information that the data supplier/administrator has encapsulated will be expanded and returned to the user. The method of this present disclosure seeks to alleviate the user's burden of contriving the proper search criteria specification to receive their desired search result, as well as other benefits. The examples and embodiments that follow will help to expound on this concept, herein referred to as MetaSpace.

### BRIEF SUMMARY

The MetaSpace method is highly effective when search criteria ambiguity exists or when a specific set of data and/or information elements wants to be delivered without other search results causing a distraction. For instance a brand advertiser may want to use the MetaSpace method when they want to segregate themselves from their competitors who are also usually part of the search results typically returned by internet search engines when a search is performed using ambiguous or general search criteria. An example of how a MetaSpace could be used in an ambiguous setting, could be to transfer information to a reader of a magazine concerning a photograph of interest found in the magazine. In the photo, a model is wearing a pair of women's boots that the reader desires to purchase. How does the reader search for those boots? The MetaSpace method would encapsulate data and/or information concerning aspects of the photo into a word or phrase-like code that could be placed alongside the image. Since the maximum length of a MetaSpace is 30 characters, a publisher may find it easier to work with than typical web addresses; such as the following from Amazon:

http://www.amazon.com/Rampage-Wornens-Hansel-RidingBrown/dp/BOOKHQWROS/ref=sr_1_2?s=apparel&ie=UTF8&qid=1450983798&sr=1-2&nodeID=10445813011& keywords=boots

The URL string listed above is 156 characters in length. Web addresses can get longer as they point to more specific layers of information. The length of this web address may make it difficult for a magazine publisher to handle due to page dimension limitations. Using the root of the domain as a reference, i.e. Amazon.com, would not be much help to the reader in this scenario, because the reader is looking for a specific fashionable item seen in the photo and would still be tasked with the burden of knowing what to type into the search interface at the Amazon home page. If the reader enters a generic search term such as “women's boots”, they will get ALL the women's boots available on Amazon.com, not just the ones in the photo. By enlisting a typical internet search engine and using the same search term, “women's boots”, the set of results returned would be an even larger selection to. sort through; namely as many of the “women's boots” that can be found on the Internet, which at the time of this writing is approximately 148,000,000 results according to one of the most prominent. This is a staggering amount of results, even for the most determined individual. But in this particular scenario, “women's boots” is the only search input information that the magazine reader has available to work with; they know that the item of interest in the photo they are looking at is “women's boots”. And again, the burden is placed on the person doing the search to start the process of refining their search criteria somehow. It is not efficient to make a human-being guess what a computer wants, especially since there are many different ways, i.e. algorithms, being used by computer systems to interpret what constitutes definitive search criteria input. The MetaSpace method may easily encapsulate the rather lengthy Amazon web address mentioned above, along with many other data elements associated with the photo of interest to the magazine reader of the above scenario, and condense FIG. 6 the data elements into a 3 to 30 character word or phrase-like code that is human-readable 62a. When that code is activated by being entered into a MetaSpace enabled interface 67,67a it would expand the “specific” data and/or information elements 69,69a associated with the photo in question. This data and/or information may be pre-assembled FIG. 9 through the use of a MetaSpace interface. Due to its maximum length being only 30 characters; the MetaSpace code should typically be small enough to fit somewhere on the page of a magazine in the vicinity of an image, and empower a reader with the proper input criteria with which to conduct their search. A reader would not have to assume what to enter into the search interface; that knowledge would be supplied to them directly from the source. What is novel about the method is that it uses speech communication as the primary data propagation method. As mentioned previously, the MetaSpace code is human-readable. The human-readable structure allows the primary recipient of the code to disseminate the code to an individual or en masse by speaking it. The method also helps to create an amplification effect on the code based on the influential nature of the person doing the speaking. This is a very important nuance of the system, because with the advent of Internet video sites such as “TED talks”; an influential speaker may cause mass activation of a MetaSpace code due to their particular influence on the group of listeners in the audience without requiring those listeners to have any special image capture or scanning equipment. The listeners are then empowered and motivated by the influential speaker to discover more data and/or information by activating the MetaSpace word or phrase-like code via a MetaSpace enabled interface FIG. 5-53. Other code systems such as barcode or QR code would require intermediate steps such as; does the listener have the proper capture or scanning device, does the listener have the proper capture or scanning software, is there enough lighting in the area for the visual code to register correctly, is the listener within the correct proximity to capture or scan the code accurately. These requirements are what is herein referred to as a “digital intermediary” barrier and these are just a few of them. This barrier may actually limit the flow of information rather than liberate it. The MetaSpace method is unique in this digital age, because empowering speech communication as the catalyst for data propagation is not very digital-like. The method implies that the archaic “word of mouth” transfer of information is still powerful. The method asserts that by augmenting “word of mouth” transfer; data propagation may occur more easily and more rapidly when being passed along through speech communication rather than requiring a digital intermediary in the form of image capture or scanning device as is the case with barcodes, QR codes and the like. Barcodes, QR codes, and other similar methods do not empower speech communication. The visual requirement associated with barcodes or QR codes for example, may create an information barrier in some cases because a barcode, QR code, or other similar technology is difficult to scan if it is not placed within a certain proximity of the capture or scanning device. Also barcodes, QR codes, and other similar technologies cannot be transferred verbally because they are not human-readable codes. So it easy to see how propagation of the information contained within certain code mechanisms such as barcodes and QR codes could inhibit data distribution due to their purely digital nature. Barcode, QR code, or other similar technology seem to work best in automated, machine-centric environments such as manufacturing; where a machine can continuously scan a certain area at high speed and determine what to do next based on the information received by the scanning of the code. This is great for machines, but not so great for information transfer amongst humans. Just imagine if each time you wanted to say something to your friend you first had to pull out a piece of hardware and then scan something before you could say what you wanted to say. The MetaSpace method may be a more equitable data transfer and information search solution because it lets people be more like people and computers be more like computers; instead of requiring people to figure out what computers want and computers having to interpret what people are really trying to say. MetaSpace seeks to achieve an equilibrium between the needs of people and the needs of computers. The human-readability of the MetaSpace format, with its word or phrase-like structure, allows it to be communicated verbally by humans without the need for special digital image or scanning equipment and its related software. For instance, going back to our magazine example mentioned earlier, if the MetaSpace affiliated with the photo was “Just Do It”; that phrase may be easily passed along in human conversation and is capable of being easily remembered in most cases. A digital intermediary, e.g. image capture or scanner device, is not necessary for the transfer or activation of the code; and since specific data elements are encapsulated by the MetaSpace code, those data elements are essentially transferred as well. The MetaSpace may be passed along simply by being spoken during a naturally occurring human interaction. At that point, the hearer of the word or phrase need only to remember it and activate the code by using a MetaSpace enabled interface, in order to receive the specific data and/or information encapsulated therein. We currently witness similar speech powered data transfer behavior when people tell each other to “Google this” or “Google it”. They verbally tell each other what to type into the Google search interface in order to help each other get to a particular set of search results more easily. The problem is that the search results from a standard Internet search engine may differ or may not be what the user anticipated because the results are based on a number of variables; one of the most prominent variables being web page ranking. Page Rank works by counting the number and quality of links to a web page coming in from other web pages; in order to determine a rough estimate of the importance of a website. The underlying assumption is that more important websites are likely to receive more “links in” from other websites. A key issue with the page rank method is the “page-based assumption of importance” rather than the solely specific information related to a search criterion. The MetaSpace method is based on the specifics not on assumption. In MetaSpace, the data and/or information is specified by the data supplier/administrator and the specified data elements are encapsulated by a word or phrase-like code. Hence, the MetaSpace method may be more direct on both sides of the search equation; the data supplier/administrator may disseminate the specific data they desire and the end-user may get exactly what the data supplier/administrator wants them to see. This places the search criterion obligation on the data supplier or administrator of the data, to enable the word or phrase-like code with the proper encapsulated data and/or information that will meet the expectations of the person who is in the act of searching and removes the responsibility from the one who is searching to know what criteria to enter into the search interface; because the proper search criterion has been pre-established by the data supplier/administrator of the MetaSpace and then given or conveyed to the one who is searching. This may be search optimization at its best because, to reiterate; the data may be pre-filtered and preassembled by the data supplier/administrator and the proper search criteria can be made known to the one who is searching. The MetaSpace is a “space” where one may encapsulate specific data and/or information elements, including metadata; so that those who are searching may find it with less difficulty and more precision. As the information available on the Internet continues to grow, the Metaspace method provides a level of granularity and specificity that is becoming increasingly more difficult to attain, with regards to information search; as more and more websites, devices, and platforms continuously come online.

Another verbally communicated search mechanism is called a hashtag. It is so-named because it must start with the hash or pound symbol (#). People verbally communicate hashtags to each other. TV show hosts such as Jimmy Fallon verbally communicate hashtags to mass audiences in order to help lead them to a specific location on Twitter where they may participate in the related tweets associated with the verbally communicated hashtag. In like manner, the MetaSpace method is intended to enhance the power and consistency of human speech. The MetaSpace method differs from hashtags in multiple ways. For instance, unlike the hashtag; a MetaSpace has no prefix required. Also, although the hashtag has a search criteria focus as does the MetaSpace method; it is not a governed encapsulation method. Simply stated, all hashtags are available to everyone. The hashtag merely searches Twitter for any pages on Twitter that reference a particular hashtag. Since it is not solely controlled by the one who created it, anyone can grab it and use it. The problem arises when a particular hashtag is becomes popular, a multitude of Twitter users grab it and reference their accounts with it as well. This allows them to be bubbled upwards when someone searches with that hashtag. A MetaSpace is controlled by its creator. The creator supplies the MetaSpace with the data and/or information that they want represented when the code is activated. Even if someone else tries to use another person's MetaSpace, they would only be promoting the other person's information, not their own. By activating the MetaSpace code either by manual input or via electronic scan, image capture, voice recognition, etc.; a resolution scheme is initiated such that each distinct data and/or information element encapsulated by the MetaSpace code is expanded and offers a user levels of interactivity; with the primary interaction being the capability of each data and/or information element to be selected and/or stored into a user identified data repository as a marker or index. Notice that certain MetaSpace codes can perform the function of a hashtag, but hashtags cannot perform the function of a MetaSpace code expression. By applying a prefix to a MetaSpace code with a pound symbol (#) like a hashtag, it could be used on Twitter as a hashtag; but then by activating it through a MetaSpace enabled search interface, it would function as a intended like any other MetaSpace code. The MetaSpace method also allows data elements to be dynamic, meaning that the interactive data elements may be updated by the administrator of the MetaSpace in order to maintain information relevance over time. By update, it is meant that additional data can be encapsulated and/or previously encapsulated data elements removed or changed at anytime during the lifespan of the MetaSpace without having to alter the code expression itself or any optionally associated media format(s).

Another value of the MetaSpace method is that a less important or lesser ranked website may still be able to deliver very accurate search results by incorporating a MetaSpace enabled search interface and thus may mitigate the impact of their lower ranking received from standard Internet search engines.

The MetaSpace method may also be used in conjunction with scanning, email, text messaging, and other intermediate digital technologies; but it is not a requirement. This allows for remarkable flexibility with the method as it does not inhibit use with other code mechanisms, such as QR codes, because the MetaSpace code may be embedded inside of a QR code and expanded when the QR code is scanned FIG. 1-1a in its customary manner. And because of its human-readable, word or phrase-like structure; a MetaSpace code may be passed along in emails and text messages almost as easily as it can be through speech communication. The ability to speak the code because of its human-readable structure enables it to work with voice recognition systems as well, such as Amazon Echo or the 1vee digital assistant. The data and/or information elements encapsulated by the MetaSpace method are timestamped, similar to how food products have expiration dates; although in this method the MetaSpace will not expire but it may lose relevance over time as the information becomes outdated if not maintained. The MetaSpace timestamp gives users an indication as to whether the encapsulated data and/or information elements have been properly maintained. Thusly, a MetaSpace may be updated by the data supplier/administrator in order to maintain information relevance as data and/or information changes over time. By update, it is meant that additional data can be encapsulated or previously encapsulated data elements removed or changed at anytime during the lifespan of the MetaSpace without altering the code expression itself or any optionally associated media format(s).

The method allows each MetaSpace to be paired with optional operational directives herein referred to as dynamos. Dynamos can be utilized to instruct the MetaSpace parser FIG. 2 to impose operations on itself or the encapsulated data elements or both; so that certain desired results may be achieved. Operations may differ based on the placement, frequency, and combinations of dynamos. For example the asterisk character (*) placed at the beginning of a MetaSpace code may direct the code to multiply by a certain amount, any associated reward points connected with particular data and/or information elements encapsulated by the MetaSpace code. Dynamos may also be supplied with optional criteria obtained from a server computer, user profile settings, social networks, or other information sources such as geo-location information received from the GPS of a device. For example, if a user has location services enabled on their mobile device, their GPS coordinates may be used as influential search criterion so that differing data elements may be shown based on the GPS coordinate filter. In other words, if the magazine scenario mentioned earlier were MetaSpace-enabled and uses a GPS filter option, different information could be displayed when the Metaspace code is activated in Los Angeles than when it is activated in New York. This allows for highly dynamic and contextualized information distribution. Based on the previous GPS example, the MetaSpace parser might receive something like the following: Shop Macys Now@@(40.800277, −73.952751). Referring to FIG. 14, the end-user only knows about the MetaSpace code string of characters, Shop Macys Now 141. The particular dynamo option 142, in this case gee-location lookup via two “at” symbols (˜) is enabled by the data supplier/administrator of the MetaSpace when it is initially setup or later updated FIG. 9 For GPS triggers to work, the MetaSpace should be packed with additional data and/or information elements that correspond to the range of GPS triggers desired by the MetaSpace data supplier/administrator, such as West and Northeast, and a default for when the person is not within the defined range. If the particular end-user in this example has location services enabled on their device, the GPS software on the device may pass along the GPS coordinates 143 when the MetaSpace is activated by the end-user. The ˜ dynamo 142 tells the parser FIG. 2-29 that what follows the MetaSpace code is a GPS coordinate 143 and to expand the appropriate data and/or information elements for the MetaSpace, Shop Macys Now 141; based on the attached coordinates occurring or not occurring within the designated range of West or Northeast that was setup by the data supplier/administrator. Another feature of dynamos is that they are polymorphic directives. The same dynamo, such as the plus sign symbol (+), is able to perform different operations or morph its behavior under different circumstances. For example, the plus sign symbol (+) placed between two MetaSpace codes 144 could tell the parser to concatenate the encapsulated data and/or information elements of each code and display all the data elements from each code 145 to the user. The very same plus sign symbol (+) 146, when placed between a MetaSpace code and an email address 147 may tell the parser to launch a MailTo( ) function and send the encapsulated data and/or information elements of the MetaSpace code to the email address that follows the plus sign. The previous examples of dynamo operation usage are depicted merely for illustrative purposes and are not meant to infer limitations of the system or method. Many other uses for characters, symbols, and combinations of characters together with symbols are imagined as plausible dynamo operational directives. The above GPS example also shows another novel aspect of the MetaSpace method. It shows how a MetaSpace code can be used stand-alone without a media reference. Since MetaSpace codes are designed to be easily understood, easily memorized, and easily communicated; MetaSpace codes may be used stand-alone without reference to an associated media format such as a photograph in a magazine. A user may activate a MetaSpace code just to see what is available for interaction because the MetaSpace code may be fairly self explanatory even without an available reference cue. The phrase “Shop Macys Now” from the example above, is easily understood without a visual reference cue. The unique flexibility of the MetaSpace method allows it to be used with audio-centric media such as radio broadcasts and podcasts. Also, the ability of the code to be verbally communicated and easily understood makes it very suitable for formats like radio. It would allow radio broadcasts to extend their transfer of information beyond the time constraints of their broadcast and obtain statistical analysis about which specific information elements users found most appealing.

### BRIEF DESCRIPTION OF THE DRAWINGS

FIG. 1. System overview flow diagram

FIG. 2. Parsing mechanism flow diagram

FIG. 3. System activation through manual input flow

FIG. 4. System activation through digital input (QR scan) flow

FIG. 5. Search, Marker Collection, User Registration, and User Login interface

FIG. 6. Encapsulation and expansion flow diagram

FIG. 7. Communication Channels

FIG. 8. Storefront Display embodiment diagram

FIG. 9. Data Supplier Administration interface

FIG. 10. Data Expansion view

FIG. 11. Banner Ad examples and standardized size chart

FIG. 12. Trademarked slogan internet search

FIG. 13. Trademarked slogan Metaspace search results example

FIG. 14. Dynamo operational directives

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure.

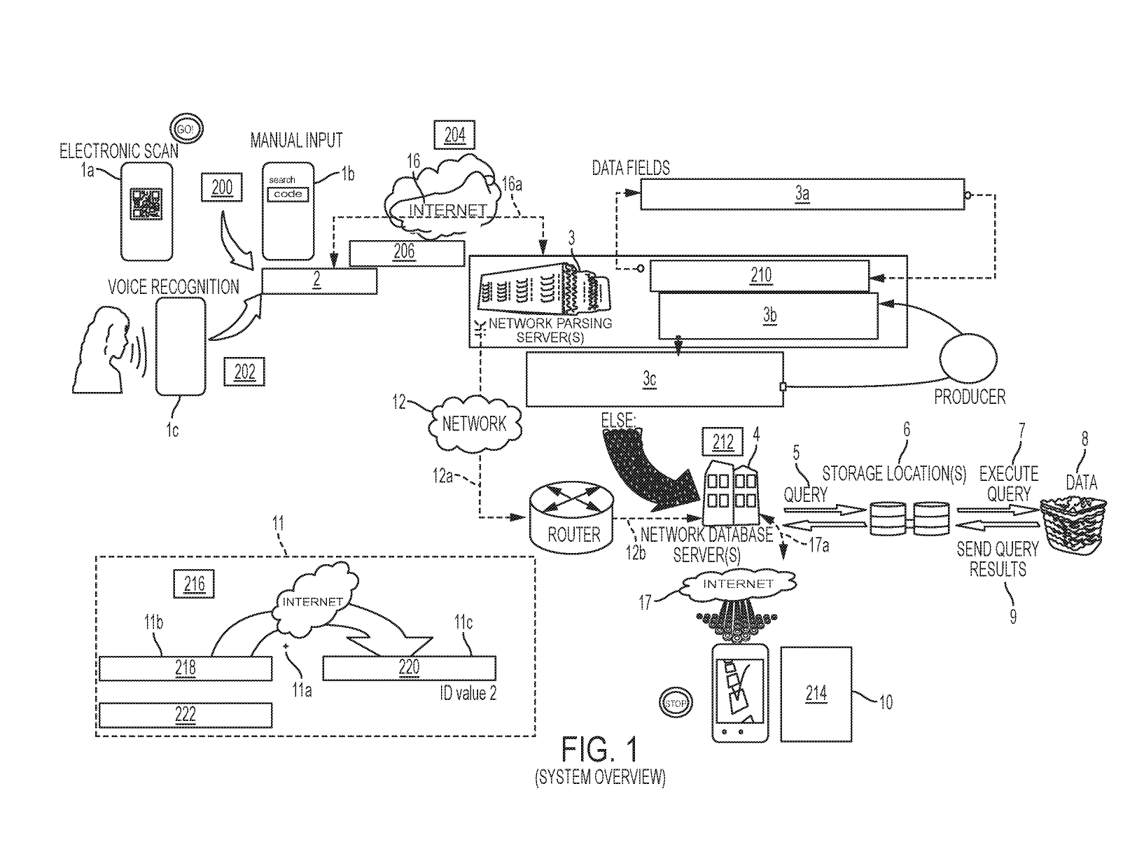

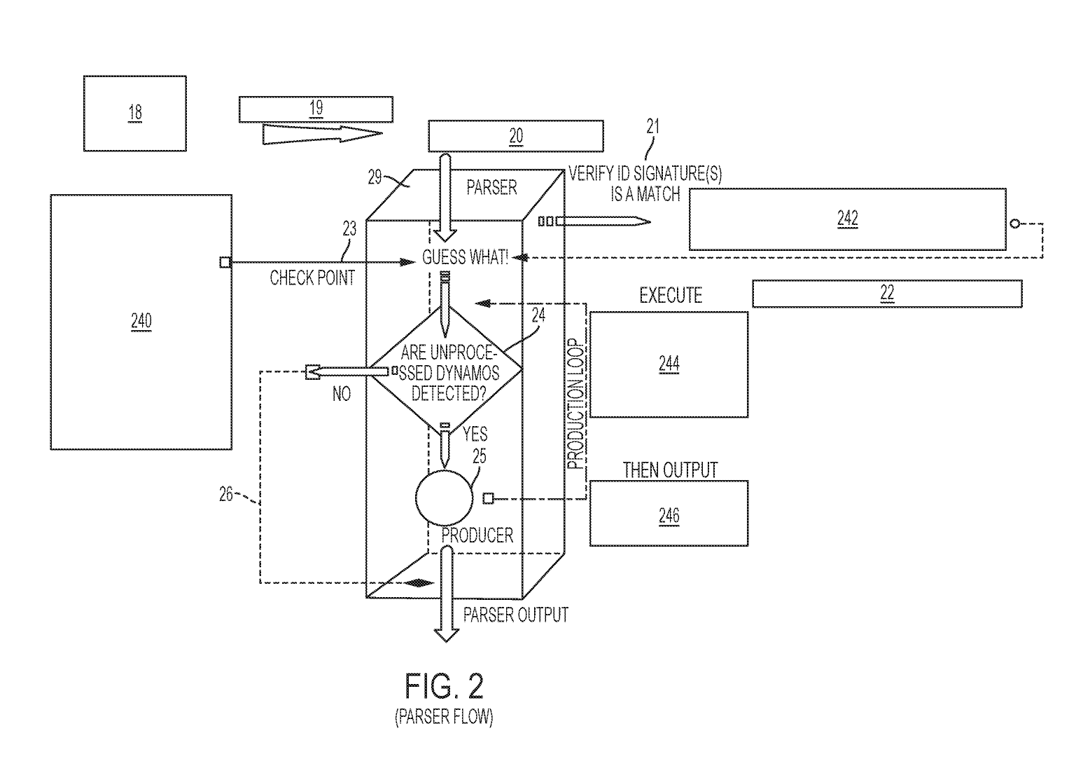

FIGS. 1 and 2 have various text boxes 2, 3a, 3b, 3c, 18, 19, 20, 22, 200, 202, 204, 206, 210, 212, 214, 216, 218, 220, 222, 240, 242, 244, 246.

Text box 2 recites “MetaSpace: Guess What! code expression.”

Text box 3a recites “{ a9957800b641b9191ff6callflc233c4: Guess What! } {dd2059465ca4cb198a62bea70cbad649: just do it} { 6375321e84b4f670a65e1aae0e014f0f: Why So Serious}.”

Text box 3b recites “check for dynamo symbols indicating operational directives (#, +, *, etc.) that were sent during activation and/or are a part of the MetaSpace code itself.”

Text box 3c recites “IF: dynamo operators are present THEN: produce date/metadata expansion parameters based on each operator.”

Text box 18 recites “MetaSpace: Guess What! code expression.”

Text box 19 recites “send MetaSpace ID signature.”

Text box 20 recites “a9957800b641b9191ff6callf1c233c4.”

Text box 22 recites “retrieve assigned MetaSpace code(s).”

Text box 200 recites “scan OR input MetaSpace expression.”

Text box 202 recites “speak MetaSpace expression.”

Text box 204 recites “code expression is sent to parser as ID signature.”

Text box 206 recites “ID Value a9957800b641b9191ff6callf1c233c4.”

Text box 210 recites “verify ID signature(s) is a match extract assigned MetaSpace code(s).”

Text box 212 recites “send production to database for data/metadata expansion.”

Text box 214 recites “Display interactive data and/or information elements using an interface.”

Text box 216 recites “MULTIPLE codes are sent to parser as ID signatures.”

Text box 218 recites “ID Value 1 5b7b35c9c657d80oa85aa0c9027d059.”

Text box 220 recites “dd2059465ca4ch198a62bea70cbad649.”

Text box 222 recites “MetaSpace: Guess What+just do it code expression(s).”

Text box 240 recites “check for dynamo symbols indicating operational directives (#, +, *, etc.) that were sent during code activation and/or are a part of the MetaSpace code. At the checkpoint, dynamo symbols that do NOT appear on the exclusion list get sent to the producer. This allows symbols to be used as part of the MetaSpace code itself because if the symbol that is part of the code is on the exclusion list, it bypasses the producer module for processing during the production loop cycle.”

Text box 242 recites “{ a9957800b641b9191ff6callflc233c4: Guess What! } {dd2059465ca4cb198a62bea70cbad649: just do it} { 6375321e84b4f670a65e1aae0e014f0f: Why So Serious}.”

Text box 244 recites “the operational directive for each dynamo sent through at the checkpoint until all directives are completed.”

Text box 246 recites “the produced parameters for proper data/metadata expansion.”

In accordance with various embodiments, a method and protocol for the encapsulation, expansion, and propagation of data, including metadata; through the use of a word or phrase-like code that is human-readable is contemplated. The method referred to as MetaSpace, is a package of precisely assembled data and/or information to help facilitate the transfer of data and/or information to an individual person or a group of persons through speech communication while maintaining the flexibility to be integrated with other data transfer systems as well. The MetaSpace method is also designed to help transform physical media information from books, magazines, newspapers, as well as other media formats; by acting as a digital bridge to connect physical media to various digital data access points.

FIG. 1 illustrates a setting in which the method may be implemented, i.e., a networked computing environment including client systems 1a, 1b, 1e and server systems 3, 4 linked by the Internet 16, 17 via network connection 16a, 17a. In the context of the networked computing environment 10, the term “client” is understood to refer to the role of the client computer system 1a, 1b, 1e as a requestor of data or services, while the term “server” is understood to refer to the role of the server computer system 3, 4 to provide such requested data or services. It is possible that the components of the server computer system 3, 4 may request data or services in one transaction, and provide data or services in a different transaction. It will be appreciated by those having ordinary skill in the art that the illustrated networked computing environment FIG. 1 is highly generalized, and that there are numerous variations with respect to implementation specificities that have not been set forth in the present disclosure.

The client systems 1a, 1b, 1e, which is presented by way of example only, may be smart mobile phones. Again, there are numerous possible variations with regard to the hardware devices that comprise the client computer system 1a, 1b, 1e and the modalities by which they connect to the Internet 16, 17 but which are not set forth in the present disclosure. Alternatives to the smart phones include systems such as desktop computers, laptop computers, tablets, and the like. Various application software may be installed on the client system 1a, 1b, 1e including, but not limited to, a web browser application, games, and a sundry other apps. The client system 1a, 1b, 1e is understood to have software instructions loaded thereon that, when executed, perform various functions in accordance with the various embodiments. Furthermore, the operating system may provide a graphical user interface (GUI) that allows a user to interact intuitively with the The client systems 1a, 1b, 1e. Common operating systems include, for example, Apple iOS, Google Android, Microsoft Windows and so forth.

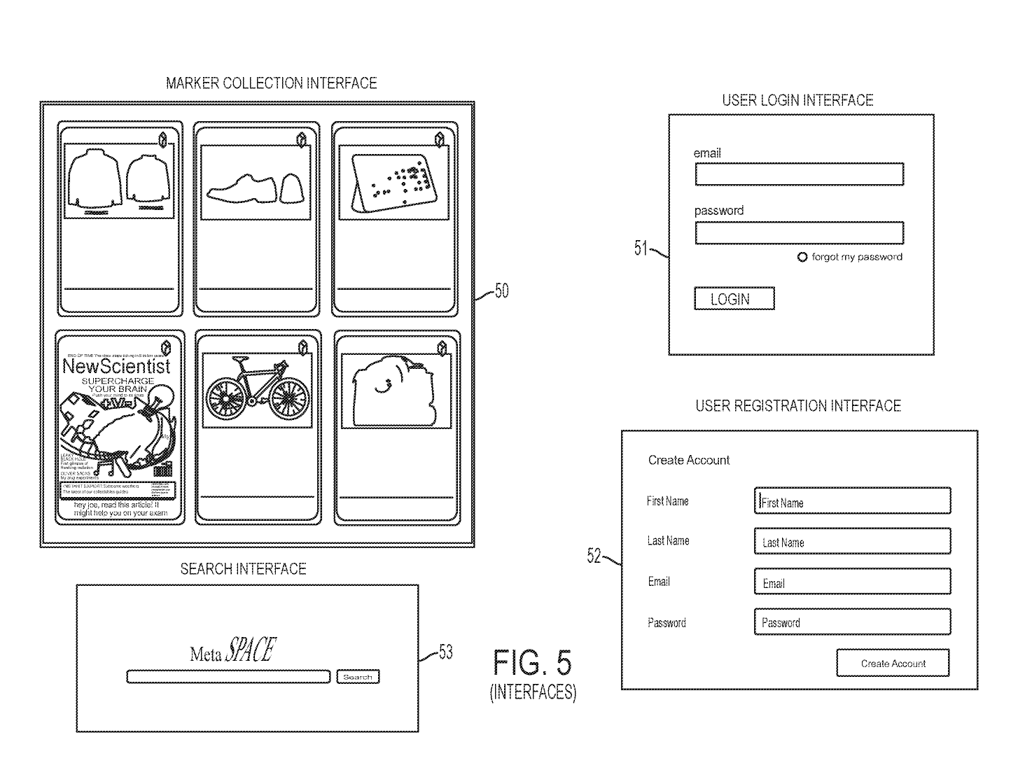

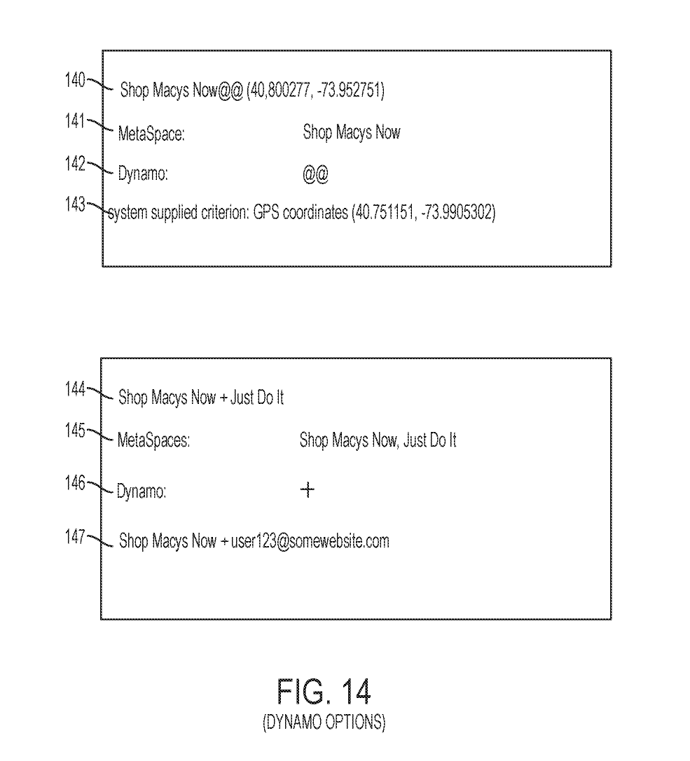

In order to retain the unique preferences of different users, it is contemplated that the system FIG. 1 establishes user accounts FIG. 5-52. Alternatively, browser cookies and other technology for tracking users are contemplated. As will be described in further detail below, the various selections made by the user throughout the session with the system FIG. 1 can be tracked using browser-based cookies or other session management modalities. Referring to FIG. 5, the user may be requested to login to the account via a login page 51. After supplying valid login credentials, the user may gain access to their identified interface(s). This user login process is standard and will be understood by those having ordinary skill in the art. If the user has not yet established an account, a new one can be created via a new account page as shown in 52. The typical first and last name, email address, and password fields may be requested. Other information may be requested during this phase as well. This user registration process is typical and will be understood by those having ordinary skill in the art. As will become apparent below, the statistics of the various users' preferences may be collected. Such statistics may be used for cross correlating the demographic of the user with various selections made by the user and to serve up various information or information in alternative forms (e.g., banner ads, alternative products, services, etc.) than those that the user initially selected but may find of additional interest. Optionally, Fees may assessed to third parties wishing to gain access to the statistical analysis related to system features, such as marker collections, code activations and any other applications associated with the MetaSpace method.

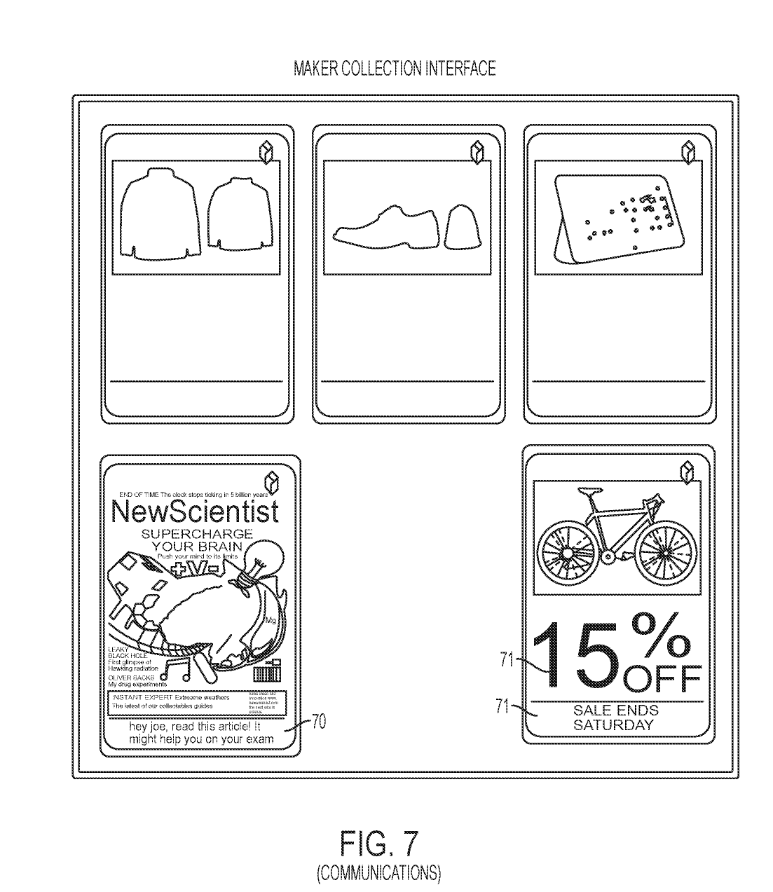

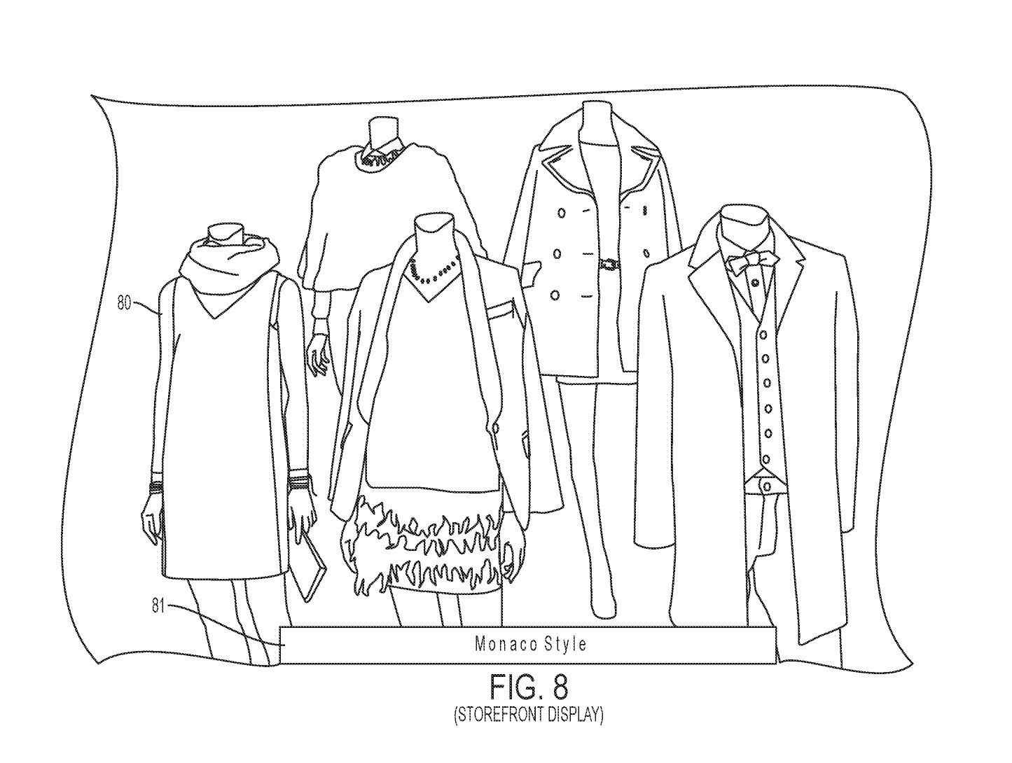

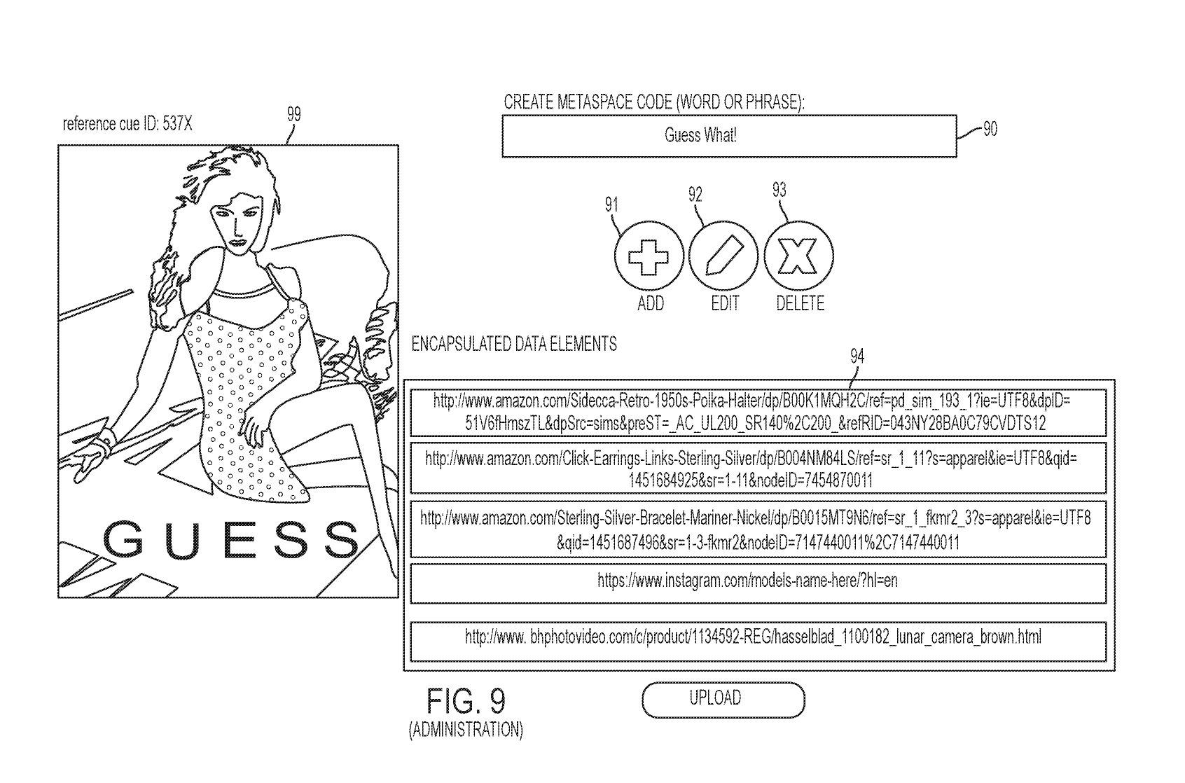

Referring to FIG. 8, in accordance with one embodiment, a clothing store may use the MetaSpace method to garner more customers as they leisurely pass by the storefront window display. The store may style their mannequins in a manner that attracts pedestrians as they pass by the store. The clothing store may create a MetaSpace such as “Monaco Style” or some other word or phrase of their choosing that fits the MetaSpace format parameters of no less than 3 and no more than 30 characters in length, and use the MetaSpace to encapsulate specific data and/or information about items used to dress the mannequins in the window 80. By printing the MetaSpace phrase-like code, “Monaco Style”, on a placard 81 and placing the placard in the storefront window 80 at the base of 1 or more mannequins; when people who pass by the storefront window see the placard 81 they can be empowered with an ability to discover information related to the clothing store. When a window shopper enters the code “Monaco Style” into a MetaSpace enabled interface FIG. 5-53, the window shopper may obtain an itemized list of the clothes and accessories being worn by the mannequins in the storefront window; with each piece of inventory from the itemized listing capable of being selected and stored by the consumer for further interactions at a later time. By way of example and not limitation, some later interactions include; allowing a consumer to purchase their selected items via the store's eCommerce solution, allowing a consumer to engage with rewards programs being offered, or allowing a consumer to communicate directly with the store via messaging channels integrated• within the marker collection interface environment FIG. 7-71. A variety of other interactions fit within the scope of the invention and are contemplated as being plausible. In this example, the consumer did not need to physically enter the store to get the information they desired and the store owner is able to get more productive use from the store's physical real estate because the MetaSpace will work even when the store is not open. The MetaSpace method also allows the store to extend its reach beyond the immediate physical surroundings by the capability of the “Monaco Style” phrase to be verbally communicated to others and activated even though the proximity of the consumer is not local. The method essentially transforms the storefront display into a sort of interactive billboard for pedestrians. As fashion changes over time, the clothing store may update the MetaSpace with new information by using the MetaSpace Administration interface FIG. 9 each time they alter the storefront window display. It is apparent that the stores website http://monacoclothing.net may be verbally communicated as well; but it is not certain that the fashionable items on the carefully styled mannequins will be found at the store's website homepage. Also, the web extension could be communicated incorrectly as many people often assume that the web domain will end with a .com extension. MetaSpace is not a web address, it is a pre-filtered, pre-packaged search criterion that may be easily distributed through speech communication and delivers specific, pre-assembled data and/or information to the anyone who activates it.

In another embodiment; universities and colleges are contemplated as beneficiaries of the MetaSpace method. Since students are the recipients of a lot of information such as class schedules, coursework requirements per class, textbooks required per class, office hours of professors, etc. A lot of this information is delivered as printed handouts or is in disparate digital locations. A professor or adminstrator could package a portion of this necessary information into a MetaSpace code and then deliver the entire collection of requirements to the entire class at once simply by speaking the word or phrase-like code or writing it on the board. For instance, a professor teaching a robotics class could encapsulate the following information:

required textbook(s) web address

office hours web address

extra credit assignments file

field trip information file

exam schedule web address

Professor email address

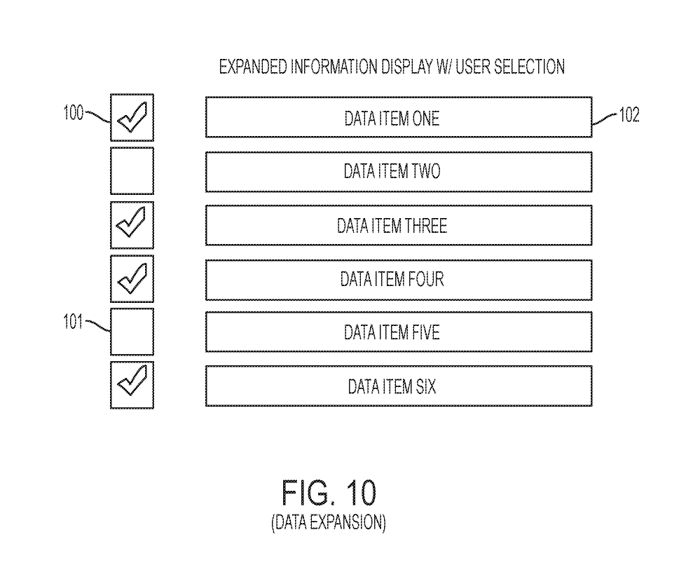

All of the information just listed above could be encapsulated by a MetaSpace such as “UCSD-ProfCallahan-Robotics101”. A student need only remember the MetaSpace code “UCSDProfCallahan-Robotics101” and enter the code into a MetaSpace enabled search interface FIG. 5-53 to retrieve the professor's pre-assembled information concerning the robotics class. Upon entering the code into the search interface FIG. 5-53, the student could interact, referring to FIG. 10, with expanded data and/or information 102 that the professor has prepared. By a student selecting 100 some or all of the information, they may store it in their own user-identified marker collection FIG. 5-50 for retrieval upon request at any time. The expanded view FIG. 10 and marker collection interfaces FIG. 5-50 are shown by way of example and not limitation as many other user interfaces for the display of data elements are imagined as plausible. Those of ordinary skill in the art will understand that there are many ways to display information to a user. The following web address is an actual UCSD Robotics link to a primary webpage on the site:

http://jacobsschool.ucsd.edu/contextualrobotics/index.shtml

It is a sub-domain of the main website of the entire university, ucsd.edu, and the webpage itself is not the common “html” extension but rather “shtml”. It is important to recognize here that web addresses need to be exact, subtle changes in an address, regardless of how slight; may create problems for people looking for information resources, since there are many possible webpage file extensions based on the technology being used to power the particular website. The sub-domain and unique extension may not be an obvious place to start a search and could be problematic to retrieving the desired information quickly. Another issue is that the above URL is not related directly to the information the student needs for Professor Callahan's class, which means the student must dig into the website to find what they need. In some cases, professors may have information about a class on their own personal website which is a bit counter-intuitive as one would expect class information to be on the university website. Since the MetaSpace method pre-packages data and/or information into a word or phrase-like code, it is of no concern to the student where to look for the class information. By the student unpacking the MetaSpace via activation of the code, the proper information locations are already established by the data supplier/administrator of the MetaSpace, in this case the data supplier being a university professor. Without using the MetaSpace method, students would need to hunt down each piece of information in separate search attempts. The MetaSpace method also helps to distribute the class information along to other classmates or personnel during the semester such as late transfer students, substitute teachers, etc., because the MetaSpace may be verbally transmitted with relative ease. There is no need for students to worry about proper sub-domains or page extensions because a MetaSpace is not a web address but rather a pre-determined search criterion. The method may also help organize data and/or information elements from disparate locations to be easily centralized. In this current exemplar, by using the MetaSpace Administration interface FIG. 9; the robotics professor may easily edit 92, add 91, and/or remove 93 encapsulated data elements without having to burden the students with any additional information about resource locations.

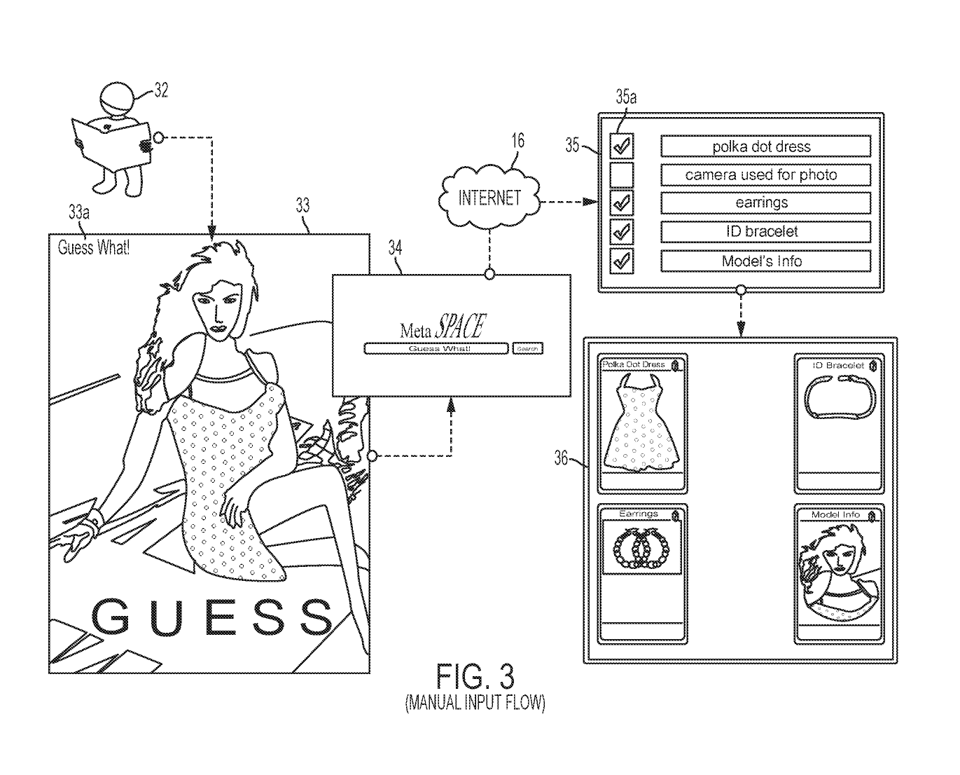

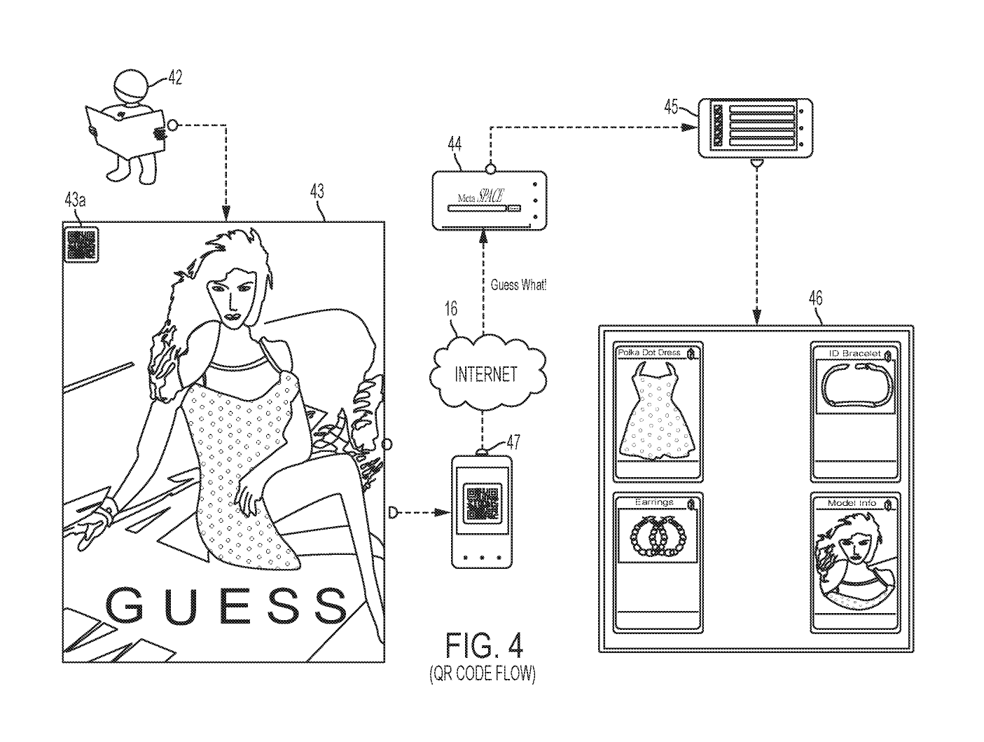

In another exemplar, a MetaSpace enabled phrase such as, Guess What!; referring to FIG. 3, would allow an international brand like the Guess clothing company to itemize the data and/or information elements associated with a promotional image 33, and thus grant consumer's access to data elements and/or information that the consumer deems most relevant. By activating the MetaSpace code 33a, via manual input 34, the MetaSpace system FIG. 1 could extract data and/or information that has been pre assembled FIG. 9-94 by the data supplier/administrator. As one can see, the amount and cryptic nature of the information would be impossible to relay quickly to someone and have it remembered by them. A web address must be input with exactness or the information being sought will not be found. Thus the MetaSpace method makes it easier to convey large amounts of information by the code being brief and human-readable. “Guess What!” is a simple phrase which will expand and deliver with ease the long and cryptic web addresses FIG. 9-94 associated with the information in the promotional image 33. Also, from the perspective of this chosen media format, there is no other practical way to place all of this information on the promotional image itself without some sort of encapsulation mechanism; to do so could ruin the promotional impact of the image. As well, once the information is expanded 35, the MetaSpace method allows the user to collect the bits of information they deem relevant 35a and store it for could themselves for future reference 36. An alternative method could be employed by the use of a QR code solution for the promotional image, referring to FIG. 4. The choice of using a QR code 43a creates a dependency which alludes to the digital intermediary barrier mentioned in the summary section of this disclosure. For the QR code version to be successful, as mentioned previously in this document, it would require intermediate steps such as; does the viewer have the proper capture or scanning device 47, does the viewer's device have the proper capture or scanning software 47, is there enough lighting in the area for the visual code to register correctly, is the viewer within the correct proximity to capture or scan the code accurately. Only if these and often other criteria are met, then access to the information contained within the QR code will be attainable. Another downside of the QR code solution is that the code is non-discernible to a human being. Thus, the valued information contained within cannot be passed along through the simplicity of speech communication. The MetaSpace method allows the expansion 45 and capture 46 of large amounts of data and/or information and facilitates the propagation of that information through speech communication because the data and/or information elements are encapsulated by the human-readable MetaSpace code. The QR code solution, on the other hand, essentially impedes much of the promotional potential of the image.

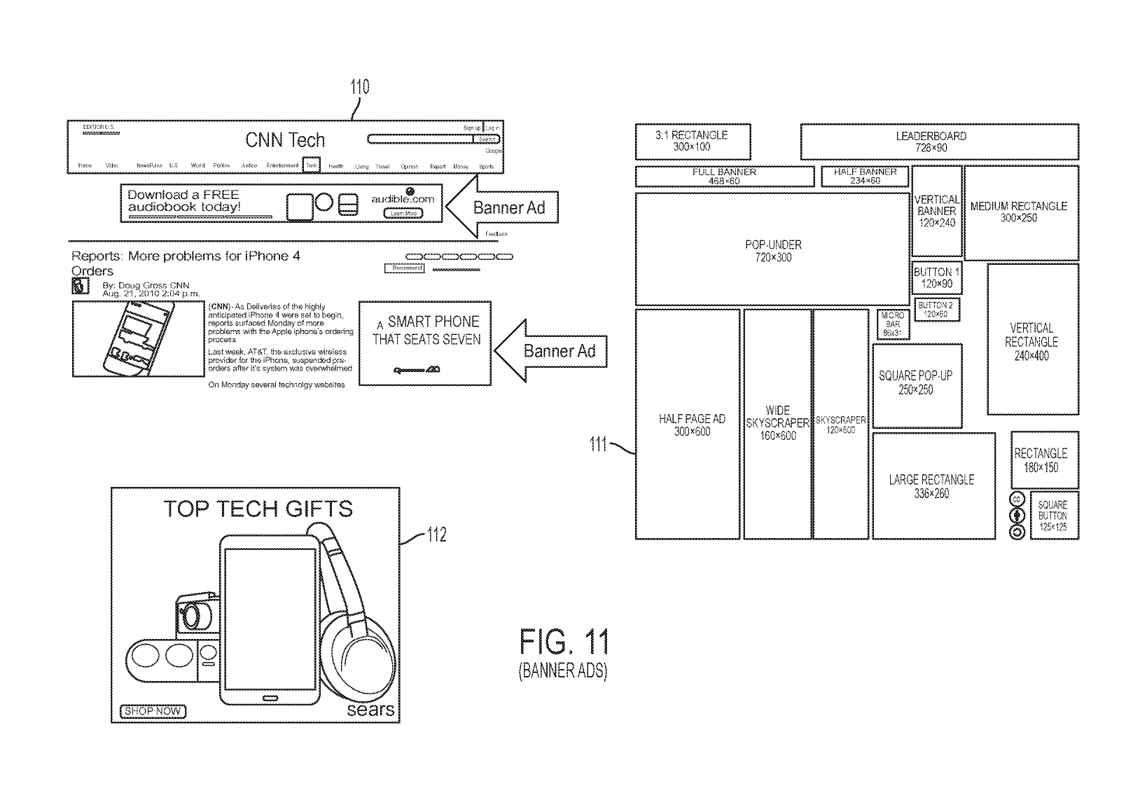

Another embodiment pertaining to internet banner ads FIG. 11 has been contemplated. Internet banner ads suffer a similar limitation of area dimension as print ads because they are subject to appear only in certain areas of a web page 110 and are subject to certain standardized dimensions 111; and although they are electronically enabled via the Internet they are not easily shareable. This is an odd situation where the shareable nature of the Internet has not really been a feature associated with banner ads or the networks that disperse them. Banner ads suffer from the aforementioned excessively cryptic and/or long web address problem, meaning the specific web location is not easy to transmit verbally, here is an example from Yahoo:

https://beapbc.yahoo.com/yc/YnY9MS4w1jAmYnM9KDE4Zm8xZmNzMihnaWQkd TFYa25ESXdOaTczcUl3MIZSQXE4Z3ZjTnpZdU1WYUIRclVBQUFBQSxzdCQxNDUxNzcw NTQ50TMzNDkxLHNpJDQONTlwNTEsc3AkMjAyMzUzODA3NSxjdCQyNSx5YngkOWxV WhlcklhazZVaUJ5Qm1LSONmZyxsbmckZW4tdXMsY31kNDQ3MDc3NzA1MSx2JDluMCxh aWQkSU1VWjBOZ25PSFktLGJpJDlyODMOMzA1NTEsbW1IJDk2MjY1OTYwMzUzMDAx NjM1MjgsciQxLGlkJHJIZGlyZWNOX2NvcHkscmQkMTFvNmkOdjlmLHlvbyQxLGFncCQz NDg4NzA5MDUxLGFwJFRMMSkp/O/*https://ad.doubleclick.net/ddm/clk/299704073;126558 439;t

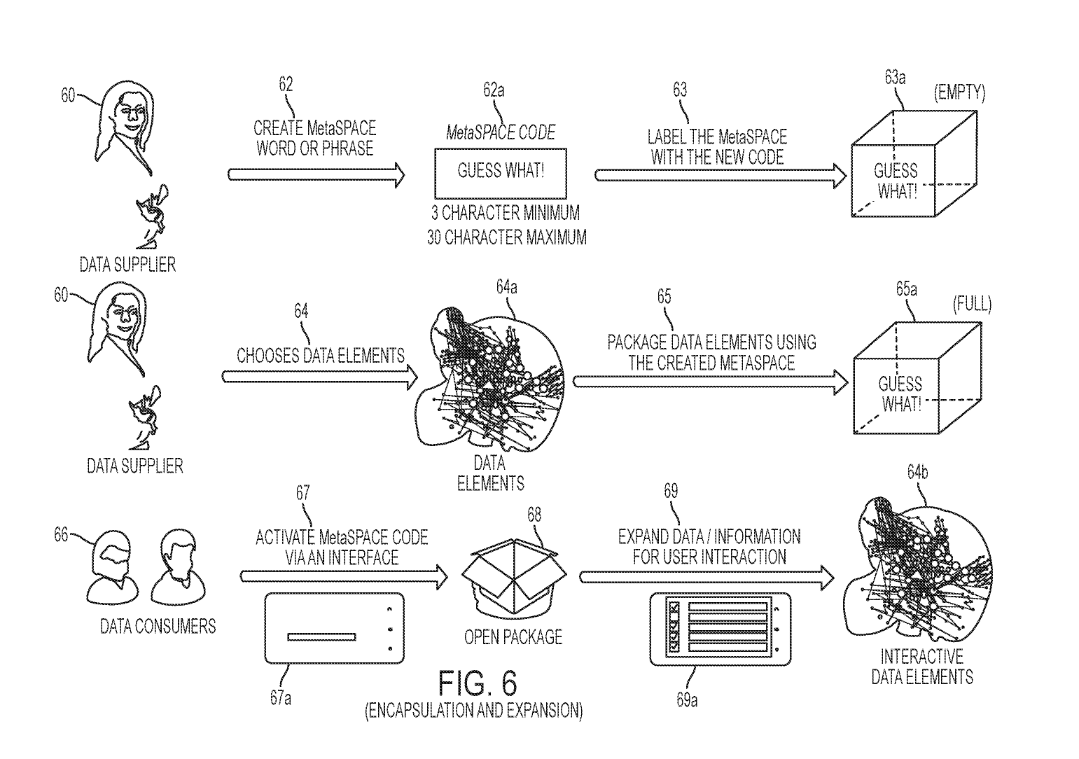

Try telling a friend about that. The typical banner ad web address makes it difficult for banner ads to be shared and propagated from one person to another without the aid of a digital intermediary such as an open web page 110. Another interesting thing about banner ads is that they are usually part of a rotation sequence similar to electronic billboards and usually this rotation is triggered when the web page is loaded or refreshed, thus one person may see a completely different banner ad than another even though they are visiting the same identical web page. The rotation of banners creates an inefficiency. This inefficiency is due to the dependence of the banner ad to be “seen” on• the page in order for any opportunity to take place; so when a banner rotates out of view, an opportunity for a particular marketer is lost. By using the MetaSpace method, banner ad information could be propagated without the banner having to be seen by every web page visitor. A visitor that happens to see a banner 112, could pass along the banner's information via a MetaSpace code, “TOP TECH GIFTS” in this particular embodiment. Then, the activation of the code FIG. 6-67 by the recipient would expand the banner's encapsulated information FIG. 6-69a without requiring the recipient to actually “see” the banner. This improves efficiency because a single view of a banner ad may result in multiple other opportunities for a marketer to garner customers because the data may be transmitted verbally as well as visually. The verbal communication by one known as an “influencer” is a great motivator for improved user response; which could create even more opportunities for a marketer to propagate the brand. The use of the MetaSpace method by the marketer could create new opportunity by liberating the marketer from the dependency on banner ad rotation frequency and web page loads.

In this next embodiment, the benefits of the MetaSpace method with regards to trademarked slogans is contemplated. According to the legal firm Fish & Richardson website (www.fr.com):

Trademarks are highly valuable assets . . . trademarks account for, on average, one-third of corporate value. Developing and protecting trademarks is not a mere “cost of doing business,” but rather an investment in customer goodwill, leading to greater customer satisfaction and higher sales.

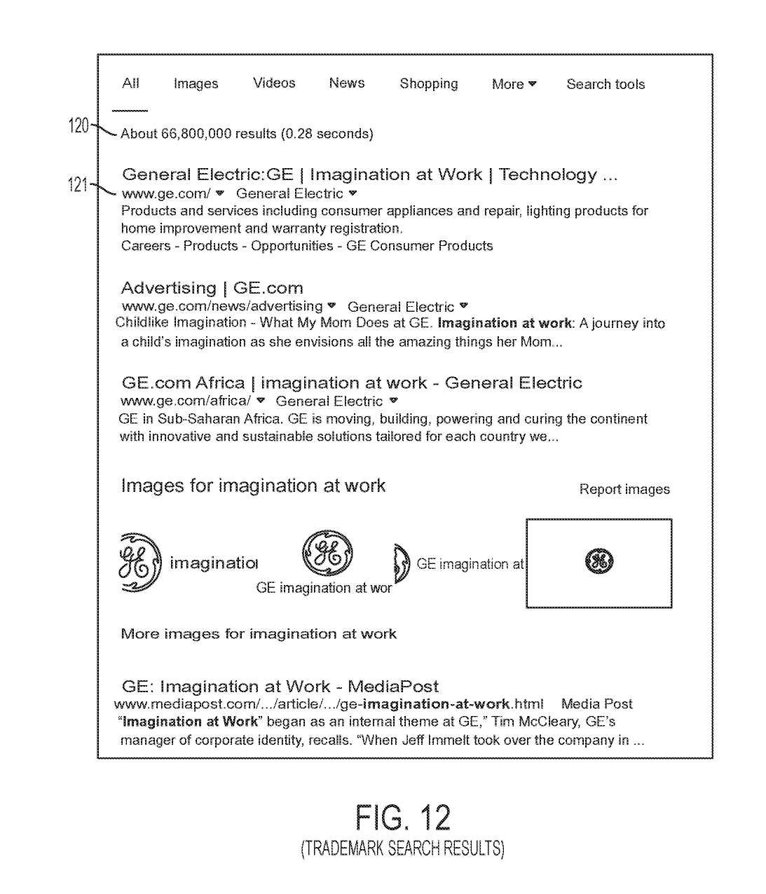

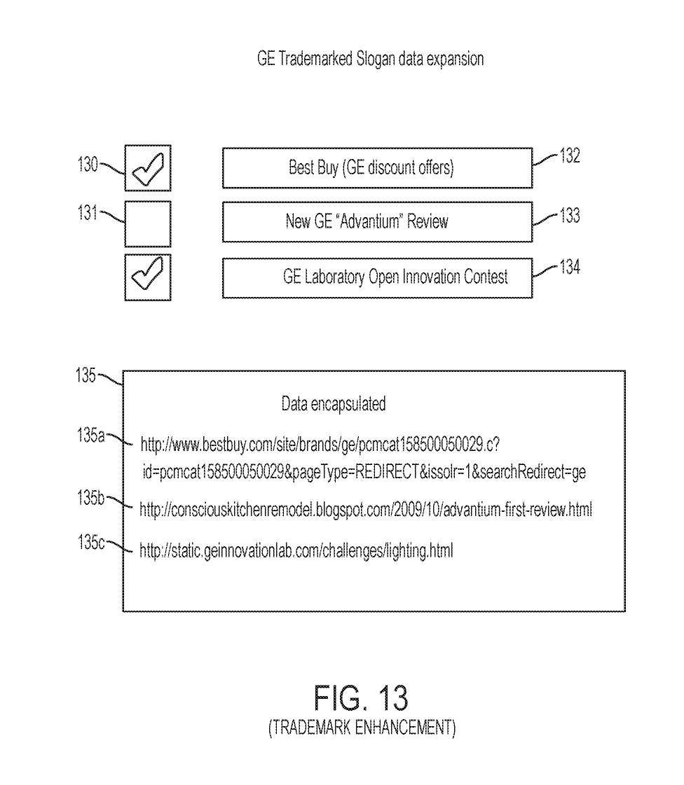

Since an investment in customer goodwill can lead to higher sales according to the above statement, why is it that trademarked slogans seem to lack practical functionality? Take for instance the General Electric trademark “Imagination at work”. Referring to FIG. 12, this phrase typed into a well known Internet search engine rendered 66 million+ results 120. The top 5 results depicted, do not render much help to the everyday consumer. Notice that no new products by GE appear in the search. What is returned is the generalized, everything from the Internet, deluge of information. In contrast, the MetaSpace method would return a pre-filtered, pre-assembled set of data and/or information elements put together for GE by a MetaSpace administrator. GE would be the data supplier, i.e. GE would supply the MetaSpace administrator with the information that they, GE, want encapsulated by the MetaSpace. This could lead to greater customer satisfaction and higher sales, as according to Fish & Richardson, is one the main goals of a trademark. Referring to FIG. 13, MetaSpace search results are much more specific. The first thing to notice is that there are only three results 132, 133, 134. This is because the MetaSpace method is not trolling the entire internet to resolve the search criteria that was input, which in this example would be the GE slogan “Imagination at work”. The first result in the set 132 is information that points directly to one of GE's main distribution channels and offers a consumer a discount incentive to buy one of their products. The second result 133 is a product review about one of GE's top performing products. The third result 134 is information pertaining to an invitation to the public to join GE in the development of new innovative products. These would be specific objectives that GE wants to accomplish and they are the only things that are returned by activating their MetaSpace enabled slogan via a MetaSpace enabled search interface FIG. 5-53. Furthermore, after activation; when a user selects a MetaSpace search result 130 it gets stored in the user's repository where they can access it at a later time. The statistical data concerning items from the MetaSpace search results may help determine more precisely how engaged a user is with the data suppliers encapsulated information. It could prove helpful in GE's marketing and public relation efforts. The ability for the slogan to actually perform a function may also help make it more memorable. By experiencing a function associated with the slogan consumers may propagate the slogan by telling each other about the usefulness of its functionality. Since the slogan is human-readable and the MetaSpace format does not require it to be encoded differently, the slogan may be passed around by verbal communication and retain its effectiveness because the slogan encapsulates the data and/or information elements. Barcodes, QR codes and other similar code mechanisms would strip away the human-readable aspect of the slogan and thus diminish its entire purpose.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method and protocol for the encapsulation, expansion, and propagation of data, including metadata; through the use of a word or phrase-like code that is human-readable, the method comprising the steps of:
creating a word or phrase-like code; encapsulating data and/or information element(s), including metadata; acknowledging the word or phrase-like code; activating the code;
expanding data and/or information elements, including metadata, due to code activation;
selecting one or more expanded data and/or information elements, including metadata;
storing selected data and/or information elements, including metadata, as a marker or index in memory for retrieval; viewing one or more markers via a marker collection interface; and communicating via integrated marker collection interface communication channels.

2. The method of claim 1 further comprising the step of creating a word or phrase-like code; the method further comprising the step of:
entering a code of choice into an interface; determining if the code of choice is already in use by another; assigning an identifier to the code; limiting the code to a minimum of 3 characters and a maximum of 30 characters, not including spaces; and the code being case-sensitive.

3. The method of claim 1 further comprising the step of viewing the marker collection interface after the storing data and/or information elements step.

4. The method of claim 3 further comprising the step of communicating via integrated marker collection interface communication channels after the viewing the marker collection interface step.

5. The method of claim 1 wherein the encapsulating step comprises the step of assigning the data and/or information elements that will be expanded when the word or phrase-like code is activated.

6. The method of claim 1 wherein the acknowledging step comprises the step of audible and/or visual recognition of the word or phrase-like code.

7. The method of claim 1 wherein the activation step comprises the step of sending the ID signature of the word or phrase-like code through a network to verify if code exists in the system; the method further comprising the step of:
parsing a verified word or phrase-like code.

8. The method of claim 7 wherein the parsing step comprises the step of retrieving the word or phrase-like code from data storage that matches the ID signature being sent at activation; analyzing for the occurrence of operational directives; calculating which encapsulated data and/or information elements to display based on whether operational directives do or do not occur and are executed or not executed.

9. The method of claim 1 wherein the expanding step comprises the step of retrieving the encapsulated data and/or information elements, including metadata, identified by the parser; the method further including the step of:
sending each of the identified data and/or information elements, including metadata, to an interface.

10. The method of claim 1 wherein the selecting step comprises the step of choosing preferred data and/or information elements displayed via an interface; the step further including the step of:
indicating what is preferred by an input request being registered and associated with a particular data and/or information element or grouping of data and/or information elements.

11. The method of claim 4 wherein the communicating step comprises the step of sending and/or receiving one or more messages, including attachments, to and/or from a single or multiple system interfaces.
